(19) United States
(12) Patent Application Publication
(10) Pub. No.: US 2007/0085287 A1
(43) Pub. Date: Apr. 19, 2007

(54) DRYWALL CART

(76) Inventor: Steven J. Wyse, Archbold, OH (US)

Correspondence Address: HOVEY WILLIAMS LLP, 2405 GRAND BLVD., SUITE 400, KANSAS CITY, MO, 64108, US

(21) Appl. No.: 11/163,330

(22) Filed: Oct. 14, 2005

(51) Int. Cl. B62B 3/10

(52) U.S. Cl. 280/79.3

(57) ABSTRACT

A drywall cart for securely and safely carrying multiple sheets of wallboard is disclosed. The drywall cart broadly includes a platform for vertically supporting the wallboard, uprights for laterally supporting the wallboard, and casters for rollably supporting the platform and uprights. The platform includes a trough for receiving and supporting the wallboard. The trough minimizes the height of wallboard disposed in the drywall cart and thereby reduces the tendency of the loaded drywall cart to tip over. The minimal height of the wallboard is further enabled by attaching the casters laterally from the trough with outriggers. The outriggers extend from the trough and permit the trough to extend below a portion of the casters.

### CROSS REFERENCE TO RELATED APPLICATION

This application is being filed contemporaneously with application for U.S. patent Ser. No. XXXXX, entitled DRYWALL CART, which is hereby incorporated by reference herein.

### BACKGROUND OF THE INVENTION

1. Field of the Invention

The present invention relates generally to a mobile drywall cart. More specifically, the present invention concerns a wheeled drywall cart configured to receive and support multiple drywall sheets, while reducing the tendency of the cart to tip over.

2. Discussion of Prior Art

Drywall, sometimes referred to as wallboard or sheetrock, has been commonly used in residential and commercial buildings for many years as a structural covering for walls and ceilings. Drywall is typically a gypsum-based plaster bonded to multiple plies of paper or felt material in the form of a rectangular sheet. Such manufactured sheets of drywall, commonly having dimensions of 4′×8′ up to 4′×12′, are difficult for one or two people to carry or arrange. Therefore, those who use or otherwise move drywall have a need for a cart to safely and reliably carry one or more drywall sheets.

It is known in the art for carts to carry multiple sheets of drywall. Some prior art drywall carts are designed to carry drywall sheets in a flat or horizontal position, while other prior art carts are designed to carry sheets in an upright position. The upright position more conveniently allows users to add and remove drywall sheets than carts that carry drywall sheets horizontally. However, these upright carts are problematic and suffer from certain limitations. One problem is that upright carts have an undesirable tendency to tip over. This occurs in part because the sheets are stored in an upright position which means the center of gravity (“CG”) is vertically spaced about two feet from the bottom of each sheet. Also, drywall carts are often rated to hold several thousand pounds of drywall and require large diameter caster wheels. Because prior art carts employ wheels below the cart's work surface, the drywall CG is raised by at least the caster diameter if not several more inches. Upright carts must also remain small enough to fit through entryways and hallways. Therefore, the combination of high CG, dimensional limitations, and drywall weight make prior art drywall carts prone to tipping over when carrying large loads.

### SUMMARY OF THE INVENTION

The present invention provides a drywall cart that does not suffer from the problems and limitations of the prior art detailed above. The inventive drywall cart includes a platform that enables the drywall cart to minimize the height of the drywall load and thereby reduce the possibility of tip over.

A first aspect of the present invention concerns a wheeled wallboard cart for supporting wallboard in a substantially upright orientation. The cart broadly includes a platform and a plurality of rotatable wheels supporting the platform. The platform includes a rigid frame and a floor. The floor presents a floor surface upon which the wallboard can be supported. The rigid frame presents a wallboard-supporting surface extending uprightly relative to the floor surface and being configured for laterally supporting the wallboard. The platform includes a plurality of outriggers for coupling each of the plurality of rotatable wheels to the platform so that the floor surface is spaced between at least a pair of the wheels.

A second aspect of the present invention concerns a wheeled wallboard cart for supporting wallboard in a substantially upright orientation. The cart broadly includes a platform and a plurality of rotatable wheels supporting the platform. The floor presents a floor surface upon which the wallboard can be supported. The rigid frame presents a wallboard-supporting surface extending uprightly relative to the floor surface and being configured for laterally supporting the wallboard. The platform includes at least a portion thereof that is spaced below a portion of at least one of the wheels.

A third aspect of the present invention concerns a wheeled wallboard cart for supporting wallboard in a substantially upright orientation. The cart broadly includes a platform and a plurality of rotatable wheels supporting the platform. The platform includes a longitudinally extending open-ended trough. The trough includes a rigid frame, a floor surface, and oppositely spaced wallboard-supporting surfaces extending uprightly and adjacent to the floor surface. The surfaces extend between the open ends. The trough is configured to receive and therein support the wallboard vertically and laterally as the wallboard extends along and beyond the trough length.

A fourth aspect of the present invention concerns a method of loading and unloading a wheeled wallboard cart. The method includes the step of attaching one or more removable uprights to the cart platform adjacent to a first side of the platform. The method further includes the step of supporting a sheet of wallboard on the platform in an upright position such that at least one of the one or more removable uprights supports the sheet.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a partially exploded left side perspective view of a drywall cart constructed in accordance with a preferred embodiment of the present invention, particularly illustrating the floor, two uprights, and one of the pivotal casters exploded away from the cart;

FIG. 2 is a right side perspective view of the drywall cart illustrated in FIG. 1;

FIG. 3 is a left side perspective view of the drywall cart illustrated in FIG. 1 showing the cart loaded with a plurality of drywall sheets of two different lengths, the short-length sheets are shown stacked against the left-side uprights and the long-length sheets are shown stacked against the right-side uprights;

FIG. 4 is an enlarged front elevational view of the loaded drywall cart illustrated in FIG. 3;

FIG. 5 is a right side perspective view of the drywall cart illustrated in FIG. 3 carrying only the shorter length drywall sheets and showing the right-side uprights removed from the cart;

FIG. 6 is a partially exploded left side perspective view of an alternative embodiment of the drywall cart illustrating an alternative frame, floor, and upright;

FIG. 7 is a right side perspective view of the drywall cart of FIG. 6;

FIG. 8 is a left side perspective view of the drywall cart of FIG. 6 showing the cart loaded with a plurality of drywall sheets stacked against the upright; and

FIG. 9 is an enlarged front elevational view of the drywall cart of FIG. 8.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

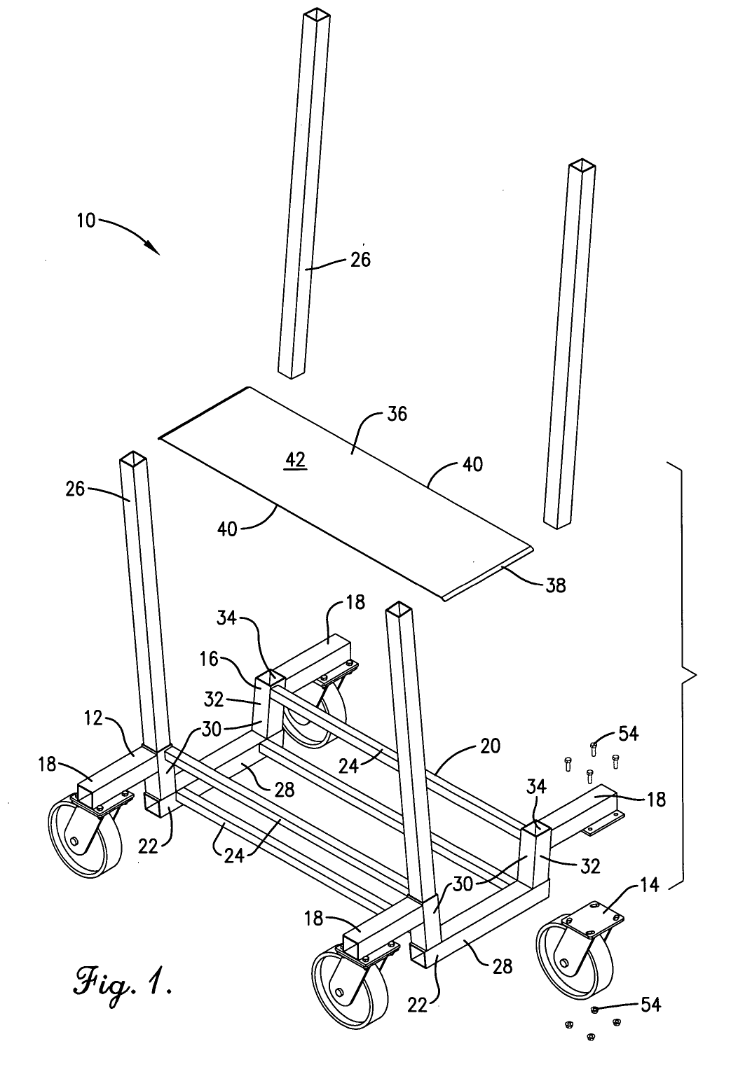

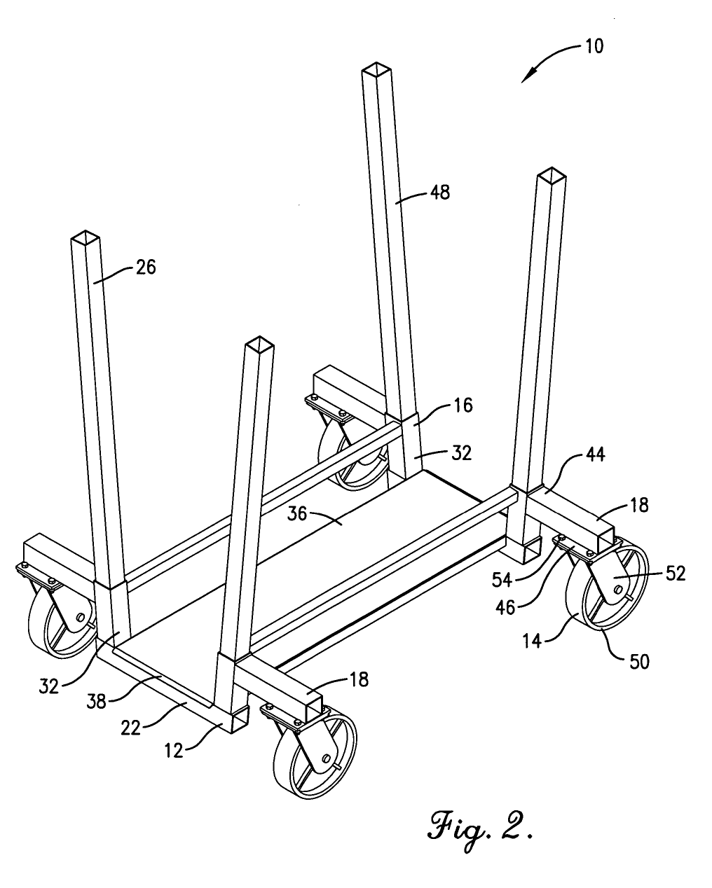

FIGS. 1 and 2 illustrate a drywall cart 10 constructed in accordance with a preferred embodiment of the present invention. The drywall cart 10 is configured to support a plurality of drywall sheets in an upright orientation. However, the principles of the present invention are equally applicable to supporting various types of wallboard or paneling including gypsum, plastic, or wood-based panels. As shown in FIGS. 1 and 2, the drywall cart 10 broadly includes a platform 12 and casters 14.

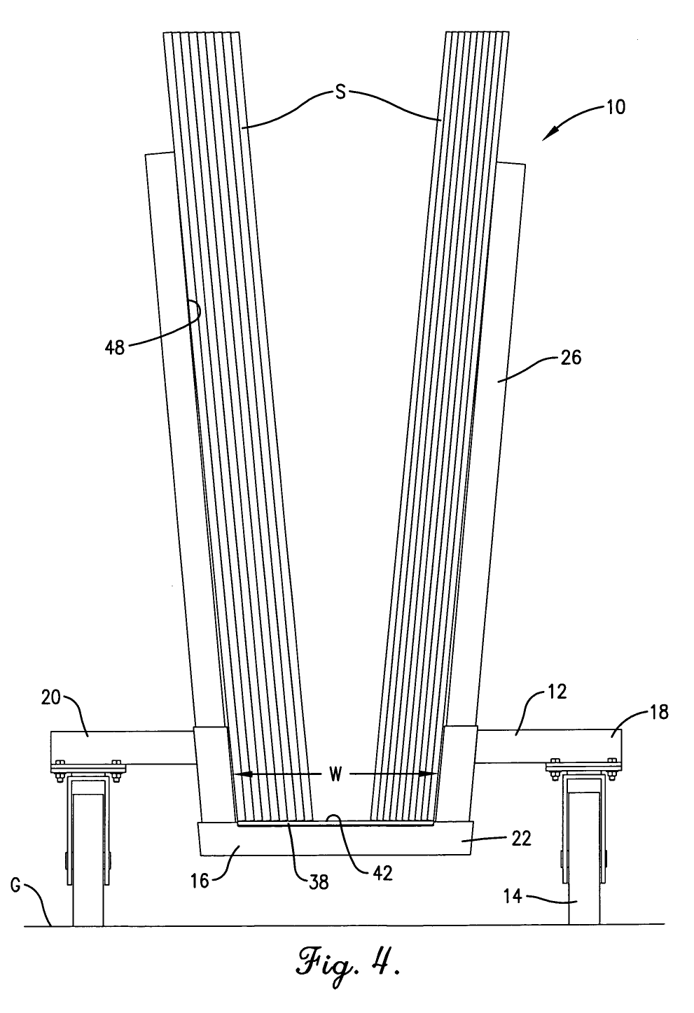

Turning to FIGS. 1-5, the platform 12 supports drywall sheets S. More particularly, the platform 12 includes a trough 16 and outriggers 18. The trough 18 includes a frame 20 with support members 22, braces 24, and removable uprights 26. Referring to FIG. 4, each support member 22 includes a bottom-most floor portion 28 and opposing upright portions 30 fixed to each end of the floor portion 28. The upright portions 30 each present lower wallboard-supporting surfaces 32. As will be discussed further, outriggers 18 are fixed to the upright portions 30. The resulting support member 22 is elongated and U-shaped, the purpose of which will be discussed in more detail. Also, the upright portions 30 each include a channel 34 for slidably receiving uprights 26. In the illustrated embodiment, each support member 22 is a welded construction of tubing sections made of carbon steel. However, it is within the ambit of the present invention that the sections could have an alternative cross-section, such as an open channel, for providing similar structural strength. In addition, the tubing sections could be constructed of other materials such as stainless steel or aluminum.

Referring to FIG. 1, two support members 22 are arranged in a substantially parallel relationship in forming the frame 20. In the illustrated embodiment, braces 24 are welded to each of the support members 22. The illustrated braces 24 are straight sections of steel tubing. In this manner, the support members 22 are interconnected with the braces 24 to form a rigid assembly. In addition, the braces 24 are longer than the support member 22 to give the frame 20 an elongated shape.

The trough 16 further includes a floor 36. In the illustrated embodiment, the floor 36 is formed from continuous carbon steel sheeting with folded-over end tabs 38 and includes sides 40 running longitudinally between the end tabs 38. The floor 36 is welded to the frame 20 so that the sides 40 run along the braces 24 and further increase the platform's strength. Again, those of ordinary skill in the art will recognize that the floor 36 could be constructed of other materials and alternatively attached to the frame 18 to provide the trough 16 with similar structural characteristics. The illustrated floor 36 presents a floor surface 42 that is smooth and substantially uninterrupted. However, the principles of the present invention are equally applicable where the floor 36 is sloped, curved or contains ridges or slots for enhanced control of wallboard sheets. One such alternative embodiment will be described below.

When viewing the platform 12 along a longitudinal direction, as in FIG. 4, the trough 16 provides the U-shaped profile of the support member 20 along its length. The internal width W of the trough 16 between the support surfaces 32 increases from bottom to top due to the inclined arrangement of the upright portions 30. The surfaces 32,42 of the trough 16 serve to support sheets S received within the trough 16. The floor surface 42 generally provides vertical support, while the support surfaces 32 generally provide horizontal support. However, it is also within the ambit of the present invention to have a trough with alternatively shaped features (e.g., bottom or sides including curves, slopes, or ridges) in order to conveniently and securely accommodate sheets of wallboard.

Turning to FIG. 2, the platform 12 further includes outriggers 18, each including an arm 44 attached to a mounting bracket 46. The arm 44 has a tubular cross-section, similar to the frame 20, and is welded to the mounting bracket 46 which attaches to one of the casters 14. The outriggers 18 are each welded to one of the upright portions 30 so as to be adjacent to the top of the trough 16 and extend outwardly therefrom, with the mounting bracket 46 being adjacent an outermost point of the platform 12. In this manner, the trough 16 extends downwardly from the outriggers 18.

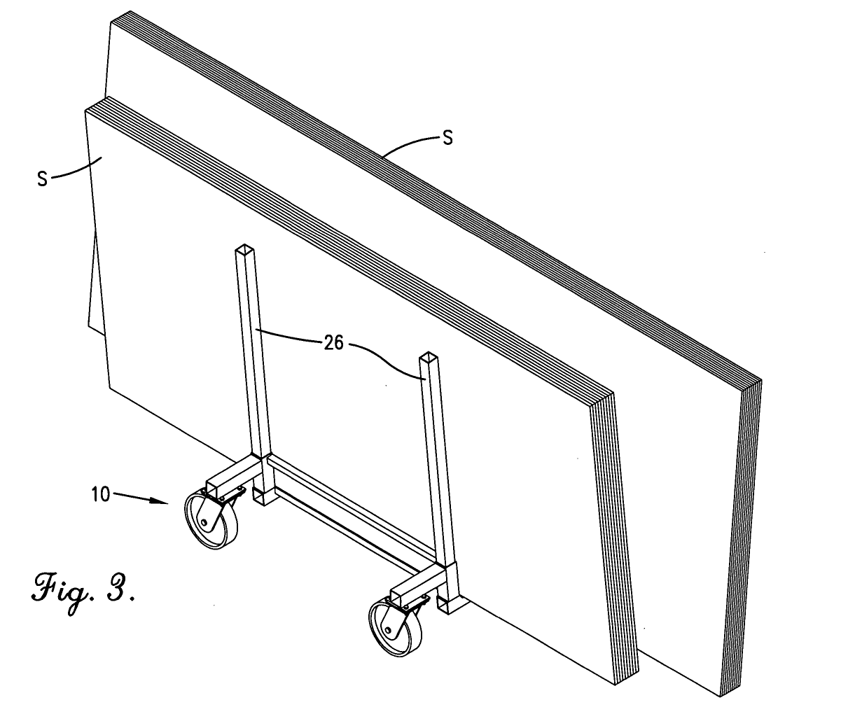

Referring to FIG. 3, the platform 12 is particularly useful in supporting drywall sheets S by the selective use of uprights 26. As discussed, the uprights 26 are slidably and removably received in the channels 34. The attached uprights 26 are each slightly inclined relative to vertical along with the upright portions 30. In this manner, the uprights 26 form upper wallboard-supporting surfaces 48 that extend along the length of the platform 12 and cooperate with the lower wallboard-supporting support surfaces 32 (see FIGS. 2 and 3) for supporting sheets S.

As shown in FIGS. 3-5, all four of the uprights 26 may be attached to support sheets S along either of the sides 40. In the preferred embodiment, two uprights 26 may be installed along one of the sides 40 to permit sheets S to be supported along only one side of the platform 12. As will be discussed, this configuration provides improved accessibility to sheets S and permits a greater range of sheet movement relative to the platform 12. Although not shown, the detached uprights 26 may be placed in brackets (not shown) on the platform 12 for removably storing the uprights 26 in a flat position.

In the preferred embodiment, shown in FIG. 2, the drywall cart 10 further includes casters 14. The casters 14 each include a wheel 50 rotatably held within a body 52 in the usual manner. The casters 14 are attached to the mounting brackets 46 with threaded fasteners 54 (see FIGS. 1 and 2). In the illustrated embodiment, the casters 14 pivot or swivel about a vertical axis. However, it is consistent with the principles of the present invention that one or more of the wheel assemblies could be fixed and thus provide the drywall cart 10 with a more limited range of motion.

As discussed, the platform 12 and the casters 14 are arranged to provide improved stability. As perhaps best shown in FIG. 4, the attached casters 14 are arranged adjacent to the outermost end of the respective outriggers 18. Thus, the drywall cart 10 has casters 14 that are positioned adjacent the outermost portions of platform 12, with the trough 16 being positioned between the casters 14. The outriggers 18 also enable the platform 12 to carry sheets S in a low vertical position relative to the casters 14. In particular, the platform 12 is located to minimize the clearance between the trough 16 and the ground G by attaching the outriggers 18 along the top of the trough 16. This permits the casters 14 to be spaced alongside the trough 16 and thereby minimize the height of the floor surface 42. Thus, the CG of the drywall sheets S is minimized to provide optimum cart stability.

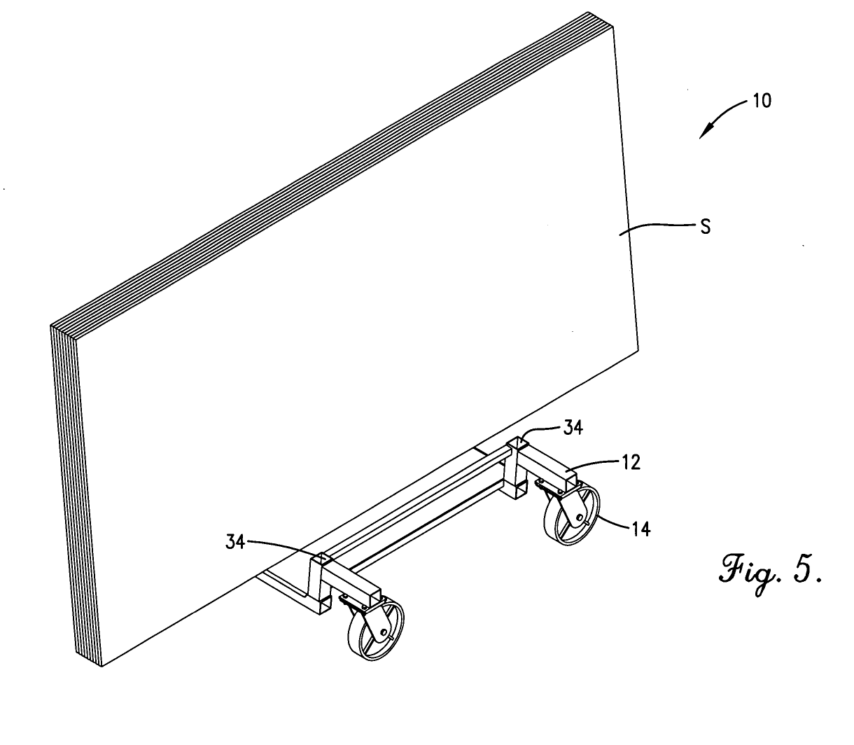

In operation, the drywall cart 10 is loaded and unloaded with a plurality of sheets S as shown in FIGS. 3-5. In one application, the use of the drywall cart 10 would involve the following steps. Initially, two of the uprights 26 are attached adjacent to one of the sides 40. In this configuration, illustrated in FIG. 5, two of the uprights 26 are detached so that two channels 34 remain open. The two attached uprights 26 of platform 12 support sheets S in an upright position. This configuration permits only one stack of sheets S to be supported on the platform 12, but provides greater access to the trough 16. In particular, ingress and egress of the sheets S relative to the platform 12 is more convenient in that the sheets S may be shifted laterally over the side 40 (where uprights 26 are not attached) into or out of its supported position without having to lift the sheets S above the height of the attached uprights 26.

The two detached uprights 26 can then be selectively attached within the open channels 34 adjacent to the other of the sides 40. In this configuration, illustrated in FIGS. 3-4, all uprights 26 are attached and sheets S are shifted so as to be supported along both sides of the drywall cart 10 in two separate stacks. This configuration permits a user to sort and stack sheets of different sizes on the drywall cart 10. The use of two stacks also distributes the load more evenly from side to side and places the combined CG of all the sheets S more centrally between the casters 14. Subsequently, any of the uprights 26 can be detached from either of the sides 40 to permit easier ingress or egress of the sheets S relative to the platform 12.

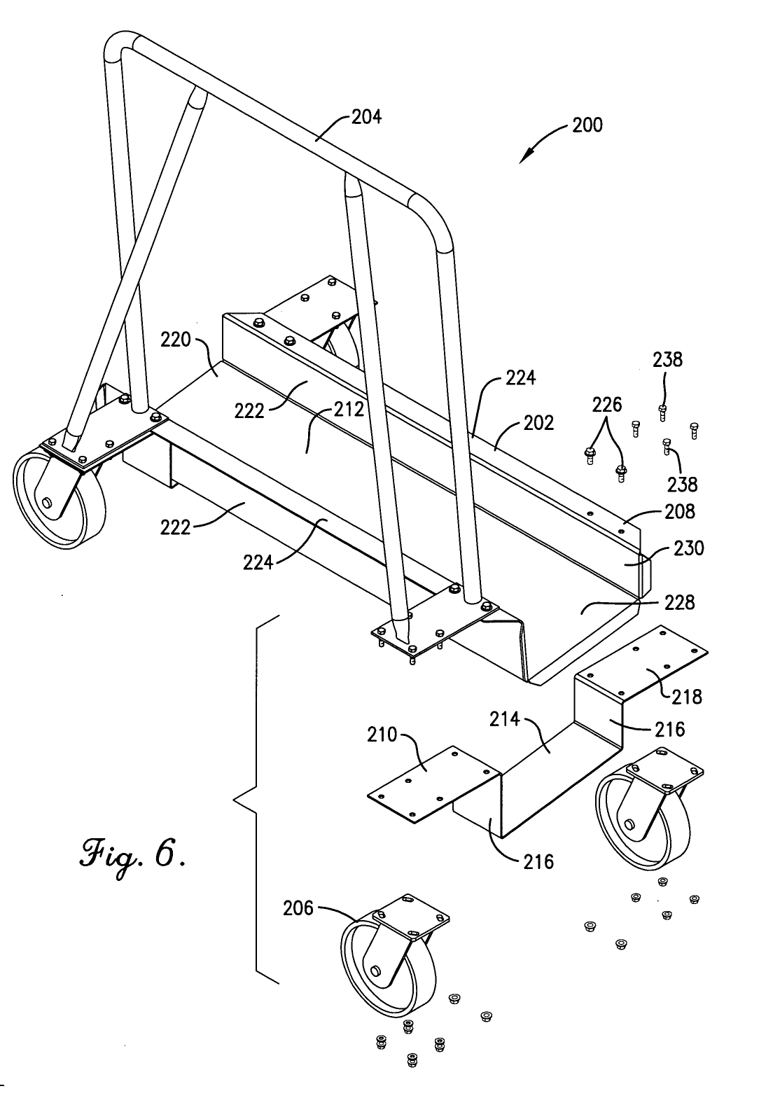

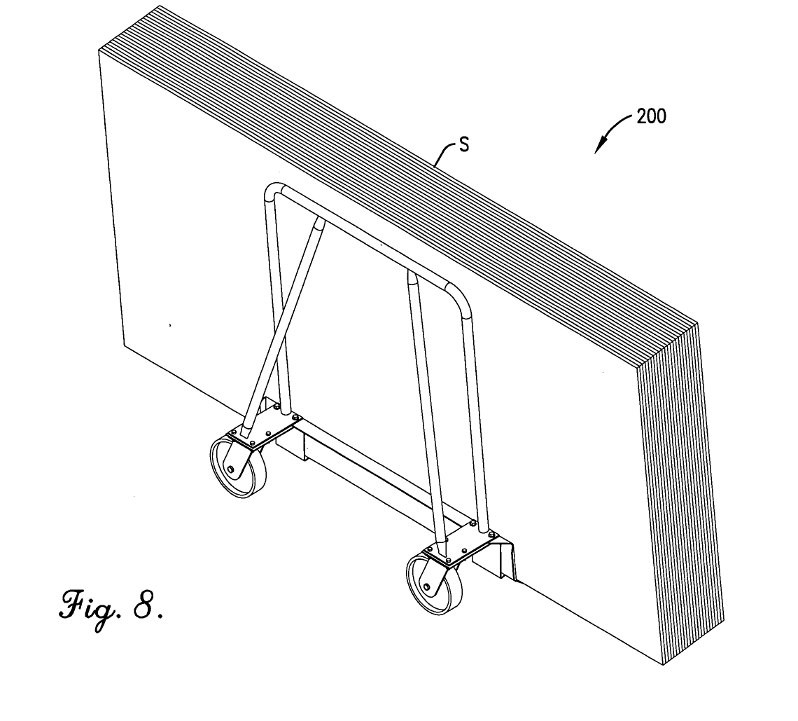

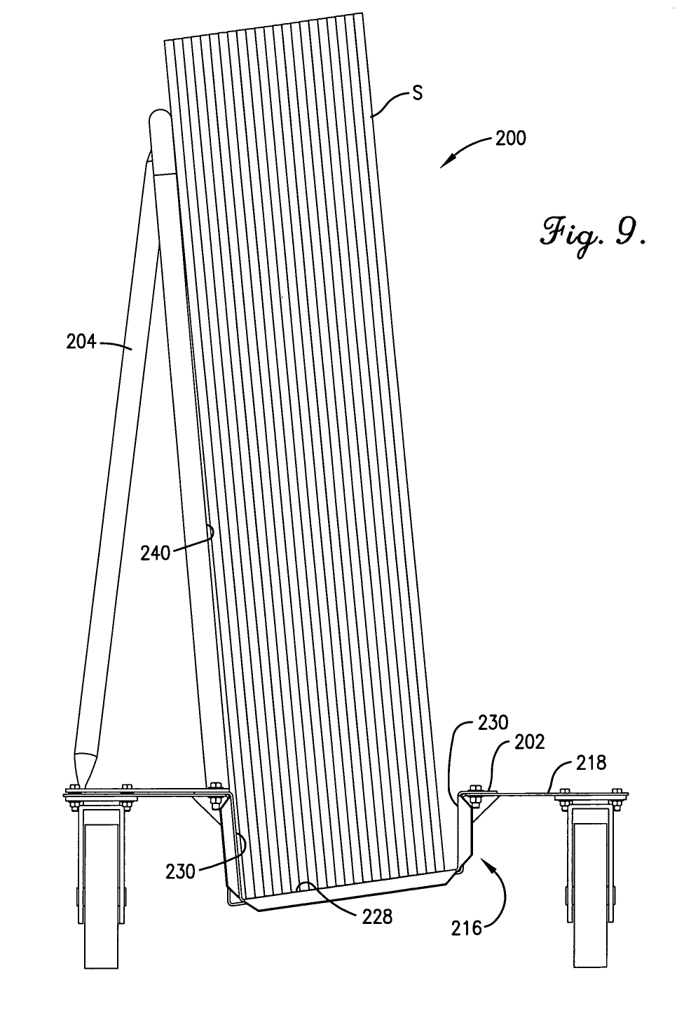

Turning to FIGS. 6-9, an alternative embodiment of the present invention is a drywall cart 200. The drywall cart 200 includes an alternative platform 202, alternative upright 204, and casters 206. The platform 202 includes a trough 208 having formed support members 210 and floor 212. The support member 210 is a formed piece of sheet metal having a bottom portion 214 and opposing upright portions 216. The platform 202 further includes outriggers 218 formed with the support members 210. As shown in FIG. 9, the outriggers 218 are substantially horizontal and the upright portions 216 are substantially vertical. The bottom portion 214, however, is slightly inclined or sloped from horizontal.

The floor 212 is also a formed piece of sheet metal having a bottom portion 220, opposing upright portions 222, and tabs 224. The bottom portion 220 is similarly inclined to the bottom portion 214 of the support members 210. The floor 212 is sized to fit closely within the support members and is attached thereto with threaded fasteners 226. The resulting trough 208 presents a floor surface 228 and lower wallboard-supporting surfaces 230 (see FIGS. 6 and 9) that run the length of the platform 202. The width of the trough 208 increases slightly from bottom to top due to the inclined arrangement of the bottom portion 220. The slope of the bottom portion 220 biases sheets S toward the upright 204.

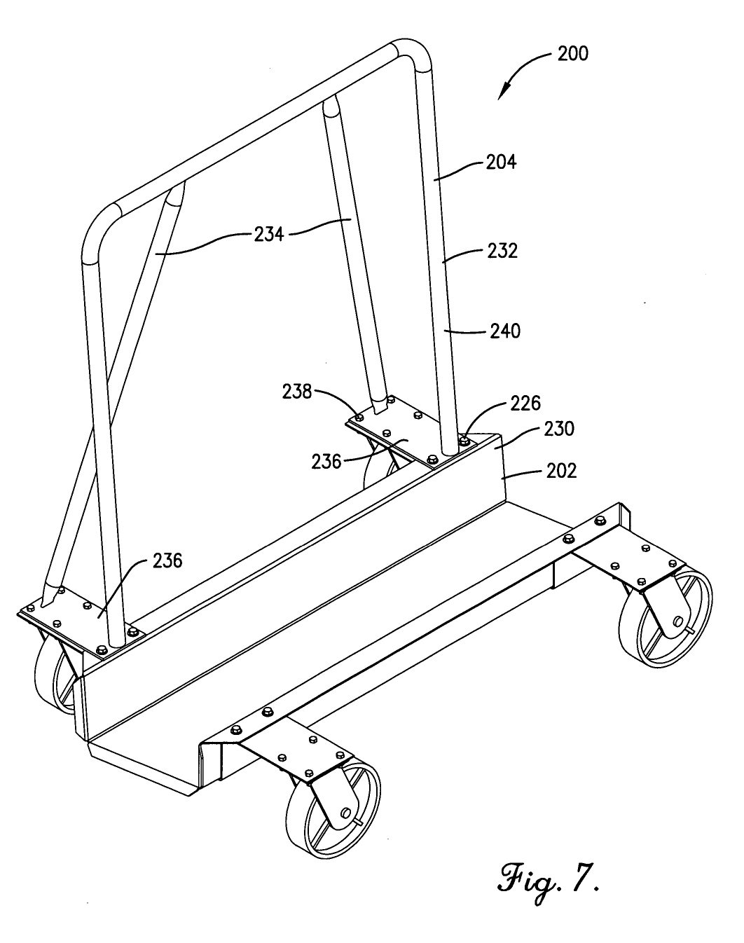

Turning to FIG. 7, the alternative upright 204 includes a tubular frame 232, tubular posts 234, and brackets 236. The frame 232, posts 234, and brackets 236 are welded together to form the rigid upright 204. The upright 204 is attached to the platform 202 with threaded fasteners 226,238 (see FIG. 6). The upright 204 further presents an upper wallboard-supporting surface 240 that cooperates with the lower wallboard-supporting surfaces 230 for supporting sheets S (see FIG. 9). The drywall cart 200 is similarly configured to the preferred embodiment to permit ingress and egress of sheets S over the open side of the drywall cart 200.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A wheeled wallboard cart for supporting wallboard in a substantially upright orientation, the cart comprising:
a platform including a rigid frame and a floor,
said floor presenting a floor surface upon which the wallboard can be supported,
said rigid frame presenting a wallboard-supporting surface extending uprightly relative to the floor surface and being configured for laterally supporting the wallboard; and
a plurality of rotatable wheels supporting the platform,
said platform including a plurality of outriggers for coupling each of the plurality of rotatable wheels to the platform so that the floor surface is spaced between at least a pair of the wheels.

2. The wheeled wallboard cart as claimed in claim 1,
said rigid frame including laterally extending support members,
said floor extending longitudinally between and over the support members.

3. The wheeled wallboard cart as claimed in claim 1,
said rigid frame including a first upright that is removably coupled to the platform along a first side of the floor and is thereby configured for supporting the wallboard across its width.

4. The wheeled wallboard cart as claimed in claim 3,
said first upright extending in an upright direction at least about 24 inches.

5. The wheeled wallboard cart as claimed in claim 1,
said first upright being inclined at an angle relative to vertical,
said angle being less than about 15 degrees.

6. The wheeled wallboard cart as claimed in claim 3,
said rigid frame including a second upright that is removably coupled to the platform along a second side of the floor and is thereby configured for supporting the wallboard across its width.

7. The wheeled wallboard cart as claimed in claim 1,
said floor surface being substantially horizontal.

8. The wheeled wallboard cart as claimed in claim 1,
said floor including longitudinally extending sides,
at least a portion of the floor surface sloping toward one of the sides.

9. The wheeled wallboard cart as claimed in claim 1,
at least one of the rotatable wheels being a caster wheel.

10. A wheeled wallboard cart for supporting wallboard in a substantially upright orientation, the cart comprising:
a platform including a rigid frame and a floor,
said floor presenting a floor surface upon which the wallboard can be supported,
said rigid frame presenting a wallboard-supporting surface extending uprightly relative to the floor surface and being configured for laterally supporting the wallboard; and
a plurality of rotatable wheels supporting the platform,
said platform including at least a portion thereof that is spaced below a portion of at least one of the wheels.

11. The wheeled wallboard cart as claimed in claim 10,
said platform including a plurality of outriggers,
said plurality of outriggers coupling each of the plurality of rotatable wheels to the platform so that the floor surface is spaced between at least a pair of the wheels.

12. The wheeled wallboard cart as claimed in claim 11,
said rigid frame including laterally extending support members,
said floor extending longitudinally between and over the support members.

13. The wheeled wallboard cart as claimed in claim 11,
said rigid frame including a first upright that is removably coupled to the platform along a first side of the floor and is thereby configured for supporting the wallboard across its width.

14. The wheeled wallboard cart as claimed in claim 13,
said first upright extending in an upright direction at least about 24 inches.

15. The wheeled wallboard cart as claimed in claim 11,
said first upright being inclined at an angle relative to vertical,
said angle being less than about 15 degrees.

16. The wheeled wallboard cart as claimed in claim 13,
said rigid frame including a second upright that is removably coupled to the platform along a second side of the floor and is thereby configured for supporting the wallboard across its width.

17. The wheeled wallboard cart as claimed in claim 11,
said floor surface being substantially horizontal.

18. The wheeled wallboard cart as claimed in claim 11,
said floor including longitudinally extending sides,
at least a portion of the floor surface sloping toward one of the sides.

19. The wheeled wallboard cart as claimed in claim 11,
at least one of the rotatable wheels being a caster wheel.

20. A wheeled wallboard cart for supporting wallboard in a substantially upright orientation, the cart comprising:
a platform including a longitudinally extending open-ended trough,
said trough including a rigid frame; and
a plurality of rotatable wheels supporting the platform,
said trough including a floor surface and oppositely spaced wallboard-supporting surfaces extending uprightly and adjacent to the floor surface,
said surfaces extending between the open ends,
said trough being configured to receive and therein support the wallboard vertically and laterally as the wallboard extends along and beyond the trough length.

21. The wheeled wallboard cart as claimed in claim 20,
said platform including a plurality of outriggers for coupling each of the plurality of rotatable wheels to the platform so that the trough is spaced between at least a pair of the wheels.

22. The wheeled wallboard cart as claimed in claim 20,
said plurality of outriggers for coupling each of the plurality of rotatable wheels to the platform so that a portion of the platform is spaced below a portion of at least one of the wheels.

23. The wheeled wallboard cart as claimed in claim 22,
a portion of the trough being spaced below the wheels.

24. The wheeled wallboard cart as claimed in claim 21,
said wallboard-supporting surfaces being inclined at an angle relative to vertical,
said angle being less than about 15 degrees.

25. The wheeled wallboard cart as claimed in claim 21,
said rigid frame including laterally extending support members,
said floor extending longitudinally between and over the support members.

26. The wheeled wallboard cart as claimed in claim 21,
said rigid frame including a first upright that is removably coupled to the platform along a first side of the floor and is thereby configured for supporting the wallboard across its width.

27. The wheeled wallboard cart as claimed in claim 26,
said first upright extending in an upright direction at least about 24 inches.

28. The wheeled wallboard cart as claimed in claim 26,
said rigid frame including a second upright that is removably coupled to the platform along a second side of the floor and is thereby configured for supporting the wallboard across its width.

29. The wheeled wallboard cart as claimed in claim 21,
said floor surface being substantially horizontal.

30. The wheeled wallboard cart as claimed in claim 21,
said floor including longitudinally extending sides,
at least a portion of the floor surface sloping toward one of the sides.

31. The wheeled wallboard cart as claimed in claim 21,
at least one of the rotatable wheels being a caster wheel.

32. A method of loading and unloading a wheeled wallboard cart, the method comprising the steps of:
(a) attaching one or more removable uprights to the cart platform adjacent to a first side of the platform; and
(b) supporting a sheet of wallboard on the platform in an upright position such that at least one of the one or more removable uprights supports the sheet.

33. The method as claimed in claim 32; and
(c) selectively attaching one or more removable uprights to the cart platform adjacent to a second side of the platform oppositely spaced from the first side.

34. The method as claimed in claim 33; and
(d) detaching at least one of the attached removable uprights from one of the first or second sides to permit ingress or egress of the sheet of wallboard relative to the platform.

35. The method as claimed in claim 34; and
(e) shifting the sheet of wallboard into or out of its supported position over the one of the first or second sides.
